(19) United States
(12) Patent Application Publication
(10) Pub. No.: US 2014/0267061 A1
(43) Pub. Date: Sep. 18, 2014

(54) SYSTEM AND METHOD FOR PRE-TOUCH GESTURES IN SENSOR DEVICES

(71) Applicant: SYNAPTICS INCORPORATED, Santa Clara, CA (US)

(72) Inventor: Tom Vandermeijden, Santa Clara, CA (US)

(73) Assignee: SYNAPTICS INCORPORATED, Santa Clara, CA (US)

(21) Appl. No.: 13/797,122

(22) Filed: Mar. 12, 2013

(51) Int. Cl. G06F 3/041

(52) U.S. Cl. CPC G06F 3/0416
USPC 345/173

(57) ABSTRACT

A processing system for an input device is configured to communicate with a host system and comprises a sensor module and a determination module. The sensor module comprises sensor circuitry and is configured to transmit transmitter signals with a plurality of transmitter electrodes and receive resulting signals comprising effects corresponding to the transmitter signals. The determination module is configured to determine, based on the resulting signals and a touch threshold, first positional information associated with a pre-touch state of an input object and second positional information associated with a touch event by the input object. The determination module is further configured to communicate data associated with the first positional information to the host system only upon occurrence of the touch event.

### FIELD OF THE INVENTION

This invention generally relates to electronic devices, and more specifically relates to sensor devices.

### BACKGROUND OF THE INVENTION

Input devices including proximity sensor devices (also commonly called touchpads, position sensing devices, or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers).

Some input devices are able to detect non-touch-related positional information related to an input object (e.g., “hover” data). That is, certain two-dimensional and/or three-dimensional values may be available to host system (i.e., a system coupled to the input device) during operation. Nevertheless, the host may be overloaded and/or distracted by such data, as it is common for an input device to “hover” over the sensing region in a manner that is unrelated to an actual touch event. Accordingly, there is a need for systems and methods that improve user experience by providing a host system with meaningful pre-touch information.

### BRIEF SUMMARY OF THE INVENTION

A processing system for an input device in accordance with one embodiment is configured to communicate with a host system and comprises a sensor module and a determination module. The sensor module comprises sensor circuitry and is configured to transmit transmitter signals with a plurality of transmitter electrodes and receive resulting signals comprising effects corresponding to the transmitter signals. The determination module is configured to determine, based on the resulting signals and a touch threshold, first positional information associated with a pre-touch state of an input object and second positional information associated with a touch event by the input object. The determination module is further configured to communicate data associated with the first positional information to the host system only upon occurrence of the touch event.

A method of providing pre-touch information to a host in accordance with one embodiment includes transmitting transmitter signals with a plurality of transmitter electrodes; receiving resulting signals comprising effects corresponding to the transmitter signals, and determining, based on the resulting signals and a touch threshold, first positional information associated with a pre-touch state of an input object and second positional information associated with a touch event by the input object, and communicating data associated with the first positional information to the host system only upon occurrence of the touch event.

A sensor device in accordance with one embodiment includes a plurality of transmitter electrodes, a plurality of receiver electrodes, and a processing system communicatively coupled to the plurality of transmitter electrodes and the plurality of receiver electrodes. The processing system is configured to: transmit transmitter signals with a plurality of transmitter electrodes; receive resulting signals comprising effects corresponding to the transmitter signals; determine, based on the resulting signals and a touch threshold, first positional information associated with a pre-touch state of an input object and second positional information associated with a touch event by the input object; and communicate data associated with the first positional information to a host system only upon occurrence of the touch event.

### BRIEF DESCRIPTION OF DRAWINGS

The present invention will hereinafter be described in conjunction with the appended drawings, where like designations denote like elements, and:

FIG. 1 is a block diagram of an example system that includes an input device in accordance with an embodiment of the invention;

FIG. 2 is a conceptual block diagram depicting an example electrode pattern;

FIG. 3 depicts a processing system in accordance with one embodiment;

FIG. 4 depicts movement of an input object with respect to a sensing region;

FIG. 5 illustrates pre-touch positional information followed by a touch event associated with an input object; and

FIG. 6 is a flowchart showing an example method in accordance with one embodiment.

### DETAILED DESCRIPTION OF THE INVENTION

The following detailed description presents a number of example embodiments and is not intended to limit the invention or the application and uses of the invention. Furthermore, there is no intention to be bound by any expressed or implied theory presented in the preceding technical field, background, brief summary, or the following detailed description.

Various embodiments of the present invention provide input devices and methods that facilitate improved usability. FIG. 1 is a block diagram of an example input device 100, in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements for detecting user input. As several non-limiting examples, the input device 100 may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be substantially uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

FIG. 2 illustrates, conceptually, an example set of capacitive sensor electrodes 200 configured to sense in a sensing region. For clarity of illustration and description, FIG. 2 shows a pattern of sensor electrodes arranged substantially perpendicular to each other, which may be referred to as an “image” sensor. It will be appreciated, however, that the invention is not so limited, and that a variety of electrode patterns and shapes may be suitable in any particular embodiment.

Sensor electrodes 210 and 220 of FIG. 2 are typically ohmically isolated from each other. In some embodiments, such sensor electrodes are separated from each by one or more substrates. For example, they may be disposed on opposite sides of the same substrate, or on different substrates that are laminated together.

In the embodiment depicted in FIG. 2, some sensor electrodes 210 (e.g., 210A, 210B, etc.) are configured as receiver electrodes, and some sensor electrodes 220 (e.g., 220A, 220B, etc.) are configured as transmitter electrodes. The capacitive coupling between the transmitter electrodes and receiver electrodes change with the proximity and motion of input objects in the sensing region associated with the transmitter electrodes and receiver electrodes. Sensor electrodes 210 might be disposed on a single layer of a substrate (either with or without jumpers), on multiple different substrates, or on different sides of the same substrate.

The receiver electrodes may be operated singly or multiply to acquire resulting signals. The resulting signals may be used to determine a “capacitive frame” representative of measurements of the capacitive couplings. Multiple capacitive frames may be acquired over multiple time periods, and differences between them used to derive information about input in the sensing region. For example, successive capacitive frames acquired over successive periods of time can be used to track the motion(s) of one or more input objects entering, exiting, and within the sensing region.

Referring again to FIG. 1, a processing system 110 is shown as part of the input device 100. The processing system 110 is configured to operate the hardware of the input device 100 (including, for example, the various sensor electrodes 200 of FIG. 2) to detect input in the sensing region 120. The processing system 110 comprises parts of or all of one or more integrated circuits (ICs) and/or other circuitry components. For example, as described in further detail below, a processing system for a mutual capacitance sensor device may comprise transmitter circuitry configured to transmit signals with transmitter sensor electrodes, and/or receiver circuitry configured to receive signals with receiver sensor electrodes).

In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like. In one embodiment, processing system 110 includes determination circuitry configured to determine positional information for an input device based on the measurement.

“Positional information” as used herein broadly encompasses absolute position, relative position, velocity, acceleration, and other types of spatial information. Example “zero-dimensional” positional information includes near/far or contact/no contact information. Example “one-dimensional” positional information includes positions along an axis. Example “two-dimensional” positional information includes motions in a plane. Example “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

Referring now to the conceptual block diagram depicted in FIG. 3, an example processing system 110 in accordance with one embodiment generally includes a sensor module communicatively coupled to a determination module 306, which is itself communicatively coupled to a host system 306. Sensor module 304 is communicatively coupled to a set of sensor electrodes 302, which may include one or more transmitter electrodes 303 and one or more receiver electrodes 305. In one embodiment, sensor electrodes 302 may be constructed from opaque or substantially opaque conductive materials, in other embodiments sensor electrodes 302 may be constructed from transparent or substantially transparent conductive material, such as patterned ITO, ATO, carbon fiber nanotubes, or other substantially transparent materials.

Sensor module 304 includes any combination of software and/or hardware (e.g., transmitter circuitry) configured to transmit transmitter signals with one or more of transmitter electrodes 303, and receive, with receiver electrodes 305, resulting signals comprising effects corresponding to the transmitter signals.

Determination module 306 includes any combination of hardware and/or software configured to determine, based on the resulting signals and a touch threshold, first positional information associated with a pre-touch state of an input object (e.g., input object 140 of FIG. 1) and second positional information associated with a touch event by the input object. Determination module 306 is further configured to communicate data associated with the first positional information (also referred to as “pre-touch data”) to the host system only upon occurrence of the touch event.

Referring now to FIGS. 4 and 5, in one embodiment, the data associated with the first positional information includes a sequence of three-dimensional values associated with movement of the input object 140 prior to the touch event. As shown in FIG. 4, an input object (in this example, a finger) moves through space in the vicinity of a sensing region 120 (depicted, in the interest of simplicity, as a planar region). That is, a snapshot of input object 140 is provided at three consecutive positions—position 410, position 411, and position 420. Position 420 in this example corresponds to a “touch event” (indicated by the shaded region)—which is determined based on the “touch threshold,” described in further detail below. Consequently, positions 410 and 411 correspond to input object 140 being in a “pre-touch” state—that is a state that does not correspond to a touch event, but instead precedes the touch event in some suitable timeframe.

As noted above, sensor devices in accordance with various embodiments are configured to determine positional information for objects that are both at the surface of the sensor and away from the surface of the sensor. Referring to FIG. 4, for example, at position 410 the user's finger is in a first portion of the sensing region 120, and at position 420 the user's finger is in a second portion of the sensing region 120. Thus, the first portion of the sensing region is between the surface of sensing region 120 and the second portion of the sensing region.

FIG. 5 depicts a close-up of a series of three-dimensional points in space 502 that might correspond to the path of input object 140 in FIG. 4. The number and sampling rate of such points may vary depending on the particular application. In this non-limiting example, however, seven three dimensional points are illustrated prior to a touch event 520. The pre-touch data ultimately reported to the host (in this embodiment) will then include a sequence of three-dimensional values associated with these points, but only upon occurrence of touch event 520. This process is illustrated, generally, in the flow chart of FIG. 6. Initially, in step 602, the determination module determines position information associated with a pre-touch state of the input object. Next, in step 604, the determination module queries whether a touch event has occurred. If not, then the determination module loops back and continues to determine the pre-touch positional information. If, however, a touch event has occurred, the determination module communicates, to the host system, the data associated with the pre-touch positional information. (Step 606).

In the interest of simplicity, FIGS. 4 and 5 depict absolute z-axis values; however, it will be understood that such z or altitude values are generally inferred from the magnitude and shape of the image associated with input object 140, and thus do not necessarily correspond to actual, physical z values. For example, in the event that input object 140 is a gloved finger (or other partially insulated input object), it may exhibit an apparent z value that is much less than that of an un-gloved finger at the same physical altitude. Accordingly, the terms “z-axis value,” “z value”, and “altitude” as used in connection with FIGS. 4 and 5 will be understood as referring to apparent or inferred values.

While the above examples relate to the determination module sending the host system a set of three-dimensional points (along with optional time information), it might be advantageous to send the host system various computed parameters relating to those three-dimensional points. Referring again to FIGS. 4 and 5, in one embodiment, the data associated with the first position information includes a velocity of the input object at a particular point or set of points prior to the touch event. That is, the determination module may examine the three-dimensional position of points 502 and report to the host system only one or more of the positions (e.g., the last or last two such positions before the touch event) in addition to a velocity at one or more of the positions. The velocity may be determined in any suitable manner; for example, by extrapolating (or interpolating) from one or more points occurring at one or more times. In other embodiments, parameters such as acceleration and direction at one or more points are sent to the host.

In one embodiment, the touch threshold is based on a consecutive frame requirement. For example, the touch threshold may be based on whether there are n or more consecutive frames at greater than about x % of the normal touch threshold. At n equal to between about 2 and 10 (e.g., 8), and x equal to between about 10% and 40% (e.g., 30%), such a threshold has been found to be a relatively robust indicator of a finger gradually sliding into the sensing region. A variety of other values may be used to determine the touch threshold. In one embodiment, the sampling rate of consecutive frames is about 0.10 seconds; however, the invention is not so limited. In another embodiment, the touch threshold is based on a touch data level. That is, a simple percentage of a particular threshold may be used for determining the touch threshold. In one embodiment, one threshold algorithm is applied for a first portion of the sensing region, and a second threshold algorithm is used for a second portion of the sensing region. For example, one threshold algorithm is used for edges of the sensing region, while another threshold algorithm is used for non-edge (e.g., central) portions of the sensing region.

Depending upon the specific implementation and context in which processing system 110 is being employed, the particular circuit components, software, firmware, and the like that are respectively comprised by host 306 and processing system 110 may vary. Stated another way, the functional “dividing line” between host 306 and processing system 110 will vary depending upon, for example, the nature of processing system 110 and host 306. In one embodiment, host system 306 comprises what is commonly known as “device driver” software which, when suitably executed (e.g., by a processor, CPU, etc.), is configured to operate in conjunction with processing system 110. In another embodiment, host 306 comprises operating system software (e.g., Linux, Windows, Mac OS, iOS, Android, Palm OS, or the like). In yet another embodiment, host 306 comprises a conventional laptop, desktop, tablet computer, smartphone, etc. In other embodiments, host 306 comprises a smart thermostat, a remote control device, a bathroom scale, a global-positioning system (GPS) device, a kitchen appliance, or the like. The term “host” thus comprehends a wide range of embodiments in which it is desirable to receive positional information associated with an input device.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

What is claimed is:

1. A processing system for an input device, the processing system configured to communicate with a host system and comprising:
a sensor module comprising sensor circuitry, the sensor module configured to transmit transmitter signals with a plurality of transmitter electrodes and receive resulting signals comprising effects corresponding to the transmitter signals;
a determination module configured to:
determine, based on the resulting signals and a touch threshold, first positional information associated with a pre-touch state of an input object and second positional information associated with a touch event by the input object; and
communicate data associated with the first positional information to the host system only upon occurrence of the touch event.

2. The processing system of claim 1, wherein the data associated with the first positional information includes a sequence of three-dimensional values associated with movement of the input object prior to the touch event.

3. The processing system of claim 1, wherein the data associated with the first position information includes at least a position or a velocity of the input object prior to the touch event.

4. The processing system of claim 1, wherein the touch threshold is based on a consecutive frame requirement.

5. The processing system of claim 1, wherein the touch threshold is based on a touch data level.

6. The processing system of claim 1, wherein the determination module is configured to determine an input gesture based on the first positional information and the second information.

7. The processing system of claim 1, wherein the touch event is in a first portion of a sensing region of the input device, and the pre-touch state is in a second portion of the sensing region of the input device, wherein the first portion of the sensing region is between a surface of the sensing device and the second portion of the sensing device.

8. A method of providing pre-touch information to a host system, comprising:
transmitting transmitter signals with a plurality of transmitter electrodes;
receiving resulting signals comprising effects corresponding to the transmitter signals;
determining, based on the resulting signals and a touch threshold, first positional information associated with a pre-touch state of an input object and second positional information associated with a touch event by the input object; and
communicating data associated with the first positional information to the host system only upon occurrence of the touch event.

9. The method of claim 8, wherein the data associated with the first positional information includes a sequence of three-dimensional values associated with movement of the input object prior to the touch event.

10. The method of claim 8, wherein the data associated with the first position information includes at least a position or a velocity of the input object prior to the touch event.

11. The method of claim 8, wherein the touch threshold is based on a consecutive frame requirement.

12. The method of claim 8, wherein the touch threshold is based on a touch data level.

13. The method of claim 8, wherein the determination module is configured to determine an input gesture based on the first positional information and the second information.

14. A sensor device comprising:
a plurality of transmitter electrodes;
a plurality of receiver electrodes;
a processing system communicatively coupled to the plurality of transmitter electrodes and the plurality of receiver electrodes, the processing system configured to:
transmit transmitter signals with the plurality of transmitter electrodes;
receive resulting signals comprising effects corresponding to the transmitter signals with the plurality of receiver electrodes;
determine, based on the resulting signals and a touch threshold, first positional information associated with a pre-touch state of an input object and second positional information associated with a touch event by the input object; and
communicate data associated with the first positional information to a host system only upon occurrence of the touch event.

15. The sensor device of claim 14, wherein the data associated with the first positional information includes a sequence of three-dimensional values associated with movement of the input object prior to the touch event.

16. The sensor device of claim 14, wherein the data associated with the first position information includes at least a position or a velocity of the input object prior to the touch event.

17. The sensor device of claim 14, wherein the touch threshold is based on a consecutive frame requirement.

18. The sensor device of claim 14, wherein the touch threshold is based on a touch data level.

19. The sensor device of claim 14, wherein the processing system is further configured to determine an input gesture based on the first positional information and the second information.

20. The sensor device of claim 14, wherein the touch event is in a first portion of a sensing region of the sensor device, and the pre-touch state is in a second portion of the sensing region of the sensor device, wherein the first portion of the sensing region is between a surface of the sensing device and the second portion of the sensing device.
